(19) United States
(12) Patent Application Publication
(10) Pub. No.: US 2019/0158575 A1
(43) Pub. Date: May 23, 2019

(54) PLATFORM AS A SERVICE CLOUD SERVER AND MULTI-TENANT OPERATING METHOD THEREOF

(71) Applicant: Institute For Information Industry, Taipei (TW)

(72) Inventor: Kai-Yuan JAN, Taipei City (TW)

(21) Appl. No.: 15/828,331

(22) Filed: Nov. 30, 2017

(30) Foreign Application Priority Data
Nov. 23, 2017 (TW) 106140753

(51) Int. Cl. H04L 29/08; G06F 9/50

(52) U.S. Cl. CPC H04L 67/10; G06F 2009/45595; G06F 9/5022; G06F 9/5055

(57) ABSTRACT

A PaaS cloud server and a multi-tenant operating method thereof are provided. The PaaS cloud server receives an application resource request and determines an available logic circuit object according to the application resource request. The PaaS cloud server creates an FPGA service object and pairs the FPGA service object and the logic circuit object. The PaaS cloud server binds the FPGA service object with an application of the tenant and receives an application data from the application. The PaaS cloud server inputs the application data into a part logic circuit of an FGPA circuit corresponding to the logic circuit object according to the pairing of the FPGA service object and the logic circuit object so that the part logic circuit computes a result data of the application data. The PaaS cloud server returns the result data to the application.

### PRIORITY

This application claims priority to Taiwan Patent Application No. 106140753 filed on Nov. 23, 2017, which is hereby incorporated by reference in its entirety.

### FIELD

The present invention relates to a platform as a service (PaaS) cloud server and a multi-tenant operating method thereof. More particularly, the present invention relates to a PaaS cloud server and a multi-tenant operating method thereof that are capable of sharing a field-programmable gate array (FPGA) circuit.

### BACKGROUND

Cloud computing, as one of main technologies currently developed in network service, utilizes a server side and hardware connected via network to accomplish various data computation or software service required by a tenant side, and it may even provide the tenant side with a platform for software development. In this way, the hardware cost at the tenant side can be reduced remarkably, and meanwhile the production efficiency at the tenant side can be improved effectively.

On the other hand, a server for cloud computing may provide different computing chips for different tenant-side requirements, e.g., provide a general central processing unit for processing words or JPEG image file data, a graphic processing unit for processing a large number of instant image operations, a Tensorfolw processing unit for processing machine learning or a field-programmable gate array (FPGA) for providing customized adjustment. The FPGA may be voluntarily adjusted by the tenant side and has a larger flexibility in use and a better performance per watt, so the cloud computation server providing the FPGA is one of the mainstreams of development.

The cloud computation server of FPGA currently provided by companies mainly takes a low-level Infrastructure as a Service (IaaS) as the system architecture, and provides independent FPGAs for different tenant sides. Thus, the tenant side can adjust the FPGA thereof depending on its requirements for data categories, thereby optimizing data processing.

However, because the cloud computation server providing the FPGA based on the IaaS system needs to provide independent FPGAs for different tenant sides, the number of FPGAs increases as the number of tenant sides increases, and the hardware cost of the companies providing the cloud computing will be increased remarkably. Moreover, since the tenant side needs to adjust the FPGA thereof correspondingly by itself, the construction cost of the service environment required by the tenant side is also relatively high.

Accordingly, an urgent need exists in the art to establish the cloud computation server providing the FPGA on another system architecture so as to reduce the hardware cost of the companies and meanwhile improve the efficiency in service environment construction of the tenant side.

### SUMMARY

The disclosure includes a multi-tenant operating method for a platform as a service (PaaS) cloud server. The PaaS cloud server executes a field-programmable gate array (FPGA) object management module and a virtual machine. The virtual machine controls an FPGA circuit. The multi-tenant operating method can comprise: receiving, by the PaaS cloud server, a first application resource request from a first tenant via the virtual machine; determining, by the PaaS cloud server, that a first logic circuit object is available via the virtual machine according to the first application resource request, wherein the first logic circuit object corresponds to a first part logic circuit of the FPGA circuit; and creating a first FPGA service object and pairing the first FPGA service object and the first logic circuit object by the PaaS cloud server via the FPGA object management module.

The multi-tenant operating method can further comprise: binding, by the PaaS cloud server, the first FPGA service object with a first application of the first tenant via the FPGA object management module; receiving, by the PaaS cloud server, a first application data from the first application via the virtual machine; inputting, by the PaaS cloud server, the first application data into the first part logic circuit corresponding to the first logic circuit object via the virtual machine according to the pairing of the first FPGA service object and the first logic circuit object so that the first part logic circuit calculates a first result data of the first application data; and transmitting, by the PaaS cloud server, the first result data to the first application via the virtual machine.

The disclosure also includes a service (PaaS) cloud server for multi tenants, which comprises a transmission interface and a processor. Transmission interface is configured to connect with a field-programmable gate array (FPGA) circuit. The processor is configured to execute an FPGA object management module and a virtual machine, and control the FPGA circuit via the virtual machine. The virtual machine comprises an FPGA processing module. The FPGA processing module is configured to: receive a first application resource request from a first tenant; and determine that a first logic circuit object is available according to the first application resource request, wherein the first logic circuit object corresponds to a first part logic circuit of the FPGA circuit.

The FPGA object management module is configured to: create a first FPGA service object and pair the first FPGA service object and the first logic circuit object; and bind the first FPGA service object with a first application of the first tenant. The FPGA processing module is further configured to: receive a first application data from the first application; input the first application data into the first part logic circuit corresponding to the first logic circuit object via the virtual machine according to the pairing of the first FPGA service object and the first logic circuit object so that the first part logic circuit calculates a first result data of the first application data; and transmit the first result data to the first application.

### BRIEF DESCRIPTION OF THE DRAWINGS

FIG. 1A is a schematic view illustrating the operation of a PaaS cloud server according to a first embodiment of the present invention;

FIG. 1B is a block diagram of the PaaS cloud server according to the first embodiment of the present invention;

FIG. 2 is a schematic view illustrating the operation of a PaaS cloud server according to a second embodiment of the present invention;

FIG. 3A to FIG. 3B are schematic views illustrating the operation of a PaaS cloud server according to a third embodiment of the present invention;

FIG. 4 is a flowchart diagram of a multi-tenant operating method according to a fourth embodiment of the present invention; and

FIG. 5 is a flowchart diagram of a multi-tenant operating method according to a fifth embodiment of the present invention.

### DETAILED DESCRIPTION

In the following description, the present invention will be explained with reference to certain example embodiments thereof. However, these example embodiments are not intended to limit the present invention to any specific embodiment, example, environment, applications or implementations described in these example embodiments. Therefore, description of these example embodiments is only for purpose of illustration rather than to limit the present invention.

In the following embodiments and the attached drawings, elements unrelated to the present invention are omitted from depiction; and dimensional relationships among individual elements in the attached drawings are illustrated only for ease of understanding, but not to limit the actual scale.

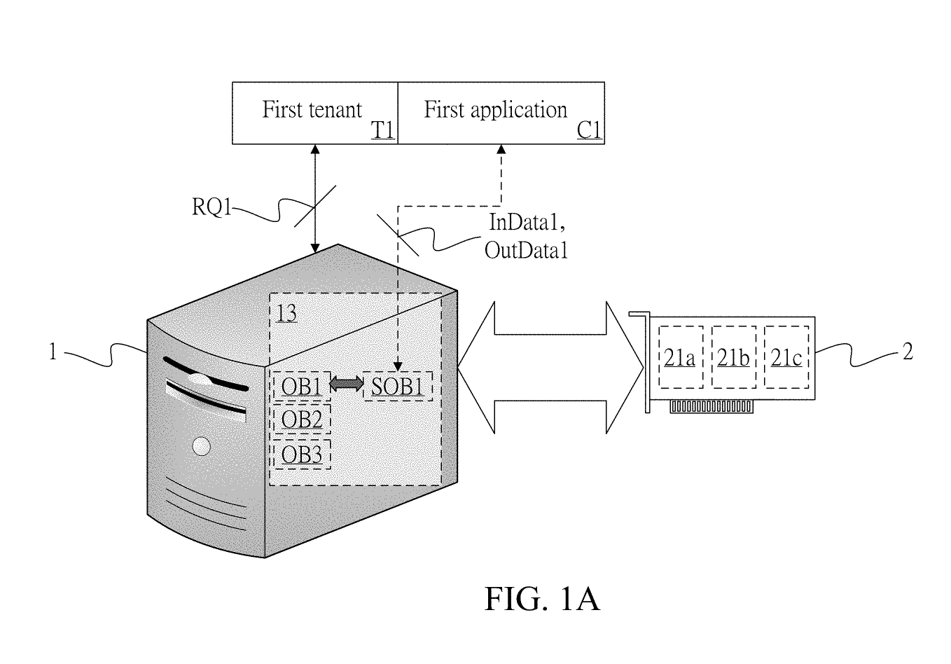

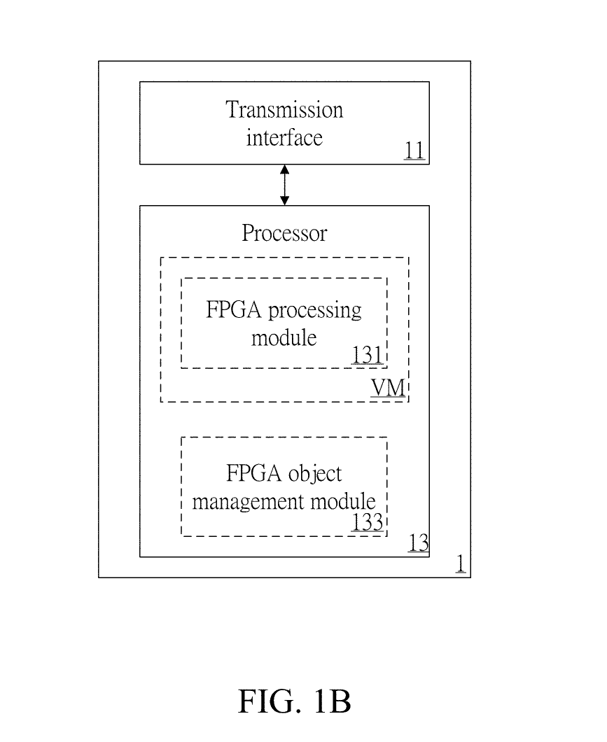

Please refer to FIG. 1A and FIG. 1B together. FIG. 1A is a schematic view illustrating the operation of a platform as a service (PaaS) cloud server 1 according to a first embodiment of the present invention, and FIG. 1B is a block diagram of the PaaS cloud server 1 according to the first embodiment of the present invention. The PaaS cloud server 1 comprises a transmission interface 11 and a processor 13. The transmission interface 11 connects with a field-programmable gate array (FPGA) circuit 2. The processor 13 executes an FPGA object management module 133 and a virtual machine VM, and controls the FPGA circuit 2 via the virtual machine VM.

First it shall be appreciated that, the transmission interface 11 and the processor 13 are electrically connected with each other. The processor 13 may be any of a central processing unit (CPU), a graphics processing unit (GPU), a microprocessor, a control element, other hardware circuit elements capable of executing relevant instructions or other computing circuits that shall be appreciated by those skilled in the art based on the disclosure of the present invention.

Moreover, the FPGA circuit 2 may exchange data with the PaaS cloud server 1 via a bus (e.g., the transmission interface 11 as a PCIe slot) or a combination of a bus and a network (e.g., the transmission interface 11 as a network card). Additionally, the FPGA circuit 2 is characterized by being programmable, so the FPGA circuit 2 can first be divided into a plurality of part logic circuits 21a to 21c capable of computing independently. The virtual machine VM configures a plurality of corresponding logic circuit objects OB1 to OB3 respectively for the plurality of part logic circuits 21a to 21c for the subsequent use and operation by the part logic circuits 21a to 21c of the FPGA circuit 2.

Specifically, in the first embodiment, the virtual machine VM comprises a FPGA processing module 131. First, when a first tenant T1 needs to use an application on the PaaS cloud server 1 and needs to operate the FPGA circuit 2 by using the PaaS cloud server 1, the first tenant T1 transmits a first application resource request RQ1 to the PaaS cloud server 1.

On the other hand, after the PaaS cloud server 1 receives the first application resource request RQ1 of the first tenant T1 via the FPGA processing module 131 of the virtual machine VM, the PaaS cloud server 1 first determines whether any logic circuit object unused is available. In other words, the PaaS cloud server 1 determines whether any corresponding part logic circuit in the FPGA circuit 2 is not used. In the first embodiment, the FPGA processing module 131 determines that a first logic circuit object OB1 is not used, and wherein the first logic circuit object OB1 corresponds to a first part logic circuit 21a of the FPGA circuit 2.

Next, the FPGA object management module 133 creates a first FPGA service object SOB1, and pairs the first FPGA service object SOB1 and the first logic circuit object OB1. Thereafter, the FPGA object management module 133 binds the first FPGA service object SOB1 with a first application C1 of the first tenant T1. It shall be particularly appreciated that, the binding herein is mainly used to bind the service object with the application so that the service object and the application share environment variables and can access corresponding parameters mutually.

Thereafter, the FPGA processing module 131 of the virtual machine VM receives a first application data InDatal from the first application C1, and inputs the first application data InDatal into the first part logic circuit 21a corresponding to the first logic circuit object OB1 via the virtual machine VM according to the pairing of the first FPGA service object SOB1 and the first logic circuit object OB1. In this way, the first part logic circuit 21a can accordingly calculate a first result data Outdatal of the first application data InDatal, and transmit the first result data Outdatal to the first application C1 to complete corresponding data computation.

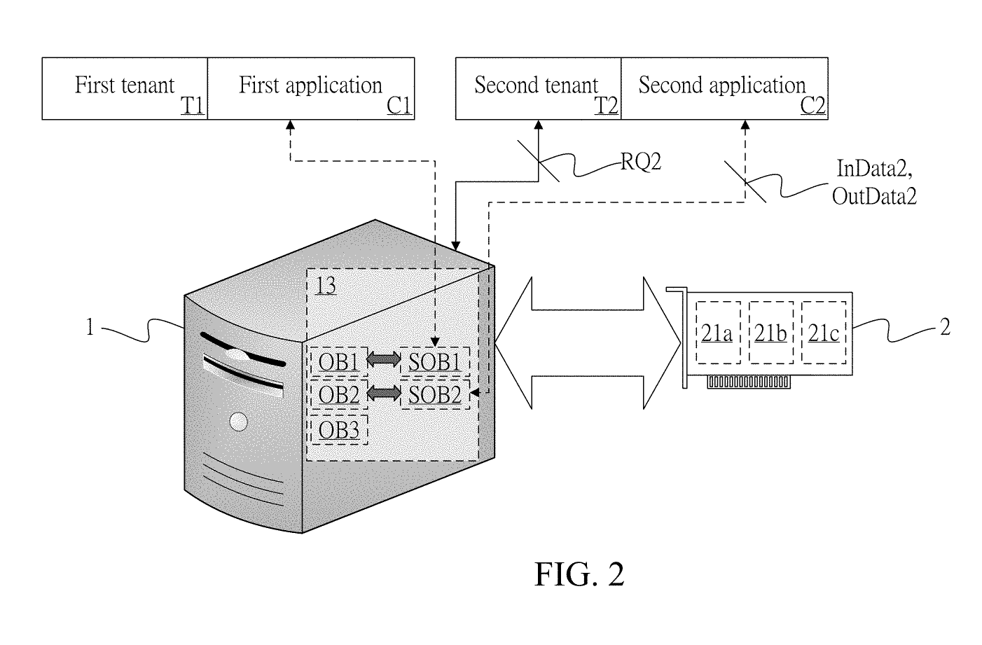

Please refer to FIG. 2, which is a schematic view illustrating the operation of a PaaS cloud server 1 according to a second embodiment of the present invention. The network architecture of the second embodiment is similar to that of the first embodiment, so elements labeled by same symbols have same functions and will not be further described herein. The second embodiment mainly further illustrates details in the multi-tenant operation of the PaaS cloud server 1 of the present invention.

First, in the case where the first tenant T1 and the first application C1 thereof are still in data exchange with the PaaS cloud server 1 (the first FPGA service object SOB1 and the first application C1 are still bound with each other), a second tenant T2 transmits a second application resource request RQ2 to the PaaS cloud server 1 when the second tenant T2 needs to use an application on the PaaS cloud server 1 and needs to operate the FPGA circuit 2 by using the PaaS cloud server 1.

On the other hand, after the PaaS cloud server 1 receives the second application resource request RQ2 of the second tenant T2 via the FPGA processing module 131 of the virtual machine VM, the PaaS cloud server 1 first determines whether any logic circuit object unused is available. In other words, the PaaS cloud server 1 determines whether any corresponding part logic circuit in the FPGA circuit 2 is not used. In the second embodiment, the FPGA processing module 131 determines that a second logic circuit object OB2 is not used, and wherein the second logic circuit object OB2 corresponds to a second part logic circuit 21b of the FPGA circuit 2.

Next, the FPGA object management module 133 similarly creates a second FPGA service object SOB2, and pairs the second FPGA service object SOB2 and the second logic circuit object OB2. Thereafter, the FPGA object management module 133 binds the second FPGA service object SOB2 with a second application C2 of the second tenant T2.

Then, the FPGA processing module 131 of the virtual machine VM receives a second application data InData2 from the second application C2, and inputs the second application data InData2 into the second part logic circuit 21b corresponding to the second logic circuit object OB2 via the virtual machine VM according to the pairing of the second FPGA service object SOB2 and the first logic circuit object OB2. In this way, the second part logic circuit 21b can accordingly calculate a second result data Outdata2 of the second application data InData2, and transmit the second result data Outdata2 to the second application C2 to complete corresponding data computation.

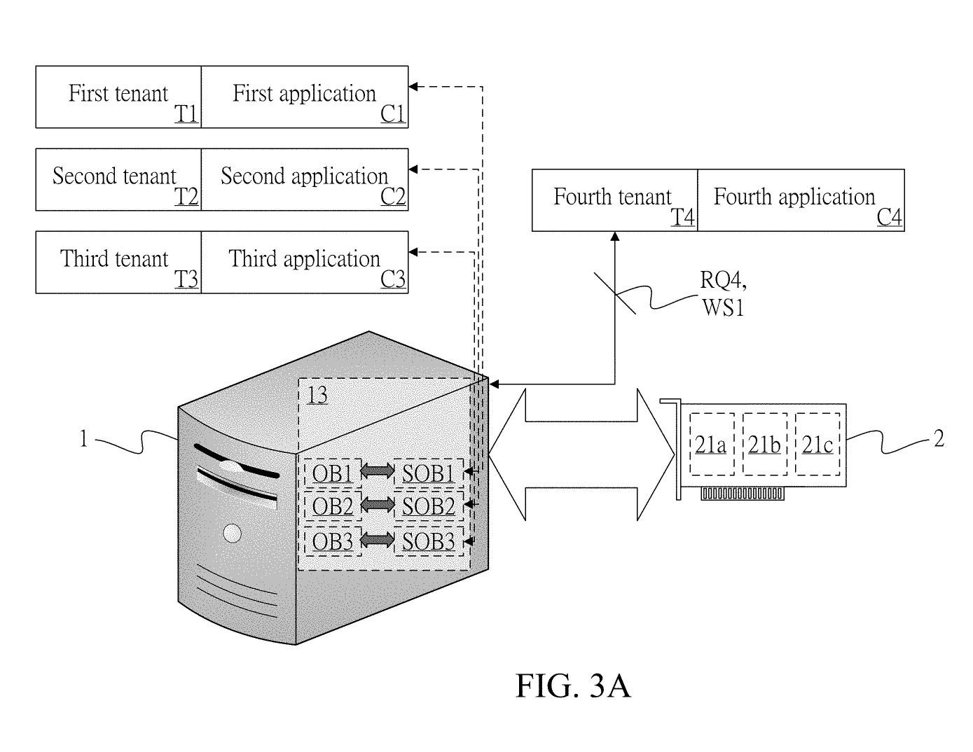

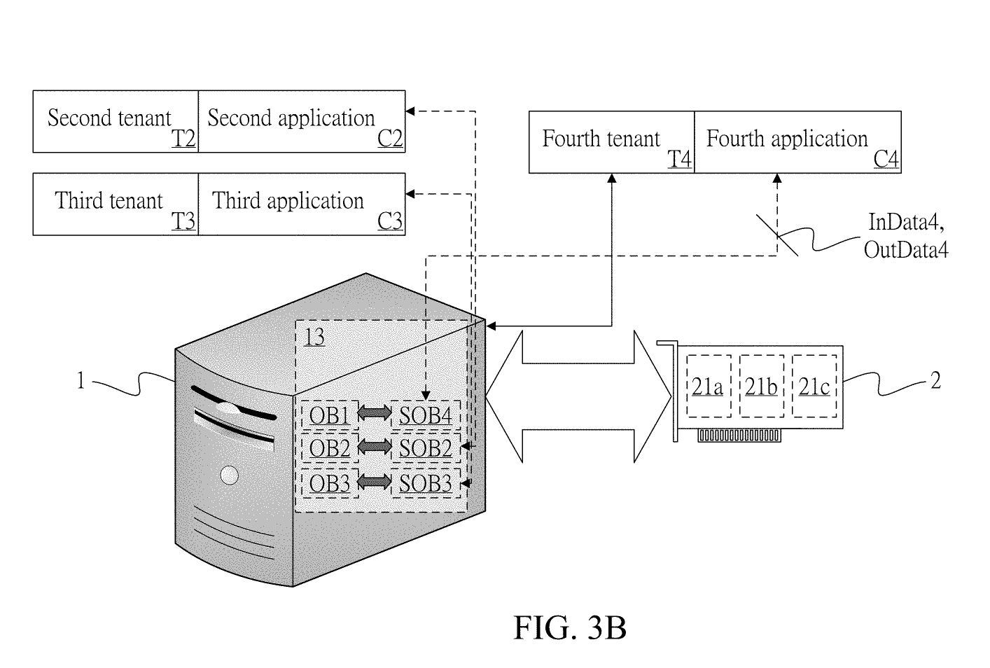

Please refer to FIG. 3A to FIG. 3B, which are schematic views illustrating the operation of a PaaS cloud server 1 according to a third embodiment of the present invention. The network architecture of the third embodiment is similar to that of the aforesaid embodiments, so elements labeled by same symbols have same functions and will not be further described herein. The third embodiment mainly further illustrates details in the multi-tenant operation of the PaaS cloud server 1 of the present invention.

First it shall be appreciated that, in the third embodiment, the first tenant T1 and the first application C1 thereof are still in data exchange with the PaaS cloud server 1 (the first FPGA service object SOB1 and the first application C1 are still bound with each other), and the second tenant T2 and the second application C2 thereof are also in data exchange with the PaaS cloud server 1 (the second FPGA service object SOB2 and the second application C2 are also bound with each other).

Meanwhile, the FPGA object management module 133 has created a third FPGA service object SOB3 and paired the third FPGA service object SOB3 with the second logic circuit object OB3, and has bound the third FPGA service object SOB3 with a third application C3 of a third tenant T3. Therefore, in the third embodiment, no logic object left unused is available.

First please refer to FIG. 3A. When a fourth tenant T4 needs to use an application on the PaaS cloud server 1 and needs to operate the FPGA circuit 2 by using the PaaS cloud server 1, the fourth tenant T4 first transmits a fourth application resource request RQ4 to the PaaS cloud server 1. On the other hand, the PaaS cloud server 1 receives the fourth application resource request RQ4 of the fourth tenant T4 via the virtual machine VM.

Next, in the third embodiment, the PaaS cloud server 1 determines that no logic circuit is available in the FPGA circuit 2 via the FPGA processing module 131 of the virtual machine VM according to the fourth application resource request RQ4. Therefore, the PaaS cloud server 1 transmits a waiting signal WS1 to the fourth tenant T4 via the FPGA processing module 131 of the virtual machine VM so as to notify the fourth tenant T4 to wait for an available resource to be released.

Please refer to FIG. 3B together. Thereafter, when the first tenant T1 and the first application C1 thereof do not need to use the PaaS cloud server 1 anymore, the PaaS cloud server 1 releases the pairing of the first FPGA service object SOB1 and the first logic circuit object OB1 and deletes the first FPGA service object SOB1 via the FPGA processing module 131 of the virtual machine VM. Thus, after the resource of the first logic circuit object OB1 is released, the FPGA processing module 131 can determine that the first logic circuit object OB1 is available according to the fourth application resource request RQ4.

Next, the FPGA object management module 133 may create a fourth FPGA service object SOB4, and pair the fourth FPGA service object SOB4 and the first logic circuit object OB1. Meanwhile, the FPGA object management module 133 binds the fourth FPGA service object SOB4 with a fourth application C4 of the fourth tenant.

Thereafter, the FPGA processing module 131 of the virtual machine VM receives a fourth application data InData4 from the fourth application C4, and inputs the fourth application data InData4 into the first part logic circuit 21a corresponding to the first logic circuit object OB1 via the virtual machine VM according to the pairing of the fourth FPGA service object SOB4 and the first logic circuit object OB1. In this way, the first part logic circuit 21a can accordingly calculate a fourth result data OutData4 of the fourth application data InData4, and transmit the fourth result data OutData4 to the fourth application C4 to complete corresponding data computation.

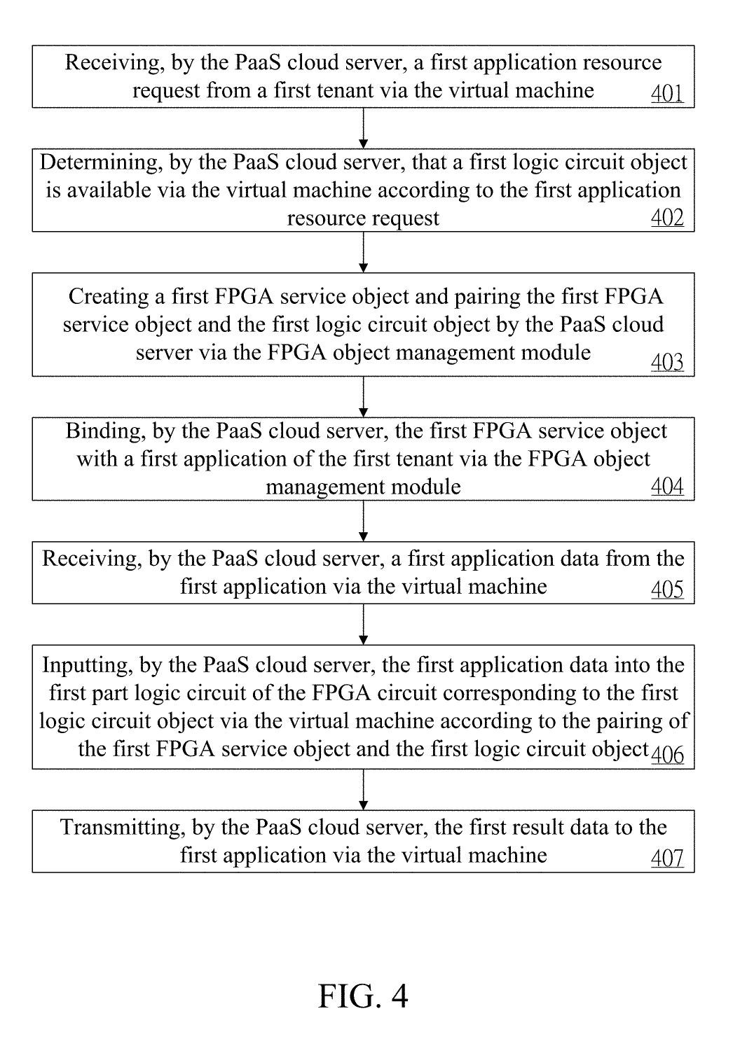

A fourth embodiment of the present invention is a multi-tenant operating method, and a flowchart diagram thereof is as shown in FIG. 4. The method of the fourth embodiment is for use in a PaaS cloud server (e.g., the PaaS cloud server of the aforesaid embodiments). The PaaS cloud server executes an FPGA object management module and a virtual machine, and the virtual machine controls an FPGA circuit. Detailed steps of the fourth embodiment are as follows.

First, step 401 is executed to receive, by the PaaS cloud server, a first application resource request from a first tenant via the virtual machine. Step 402 is executed to determine, by the PaaS cloud server, that a first logic circuit object is available via the virtual machine according to the first application resource request. The first logic circuit object corresponds to a first part logic circuit of the FPGA circuit.

Next, step 403 is executed to create a first FPGA service object and pair the first FPGA service object and the first logic circuit object by the PaaS cloud server via the FPGA object management module. Step 404 is executed to bind, by the PaaS cloud server, the first FPGA service object with a first application of the first tenant via the FPGA object management module. Step 405 is executed to receive, by the PaaS cloud server, a first application data from the first application via the virtual machine.

Thereafter, step 406 is executed to input, by the PaaS cloud server, the first application data into the first part logic circuit corresponding to the first logic circuit object via the virtual machine according to the pairing of the first FPGA service object and the first logic circuit object. In this way, the first part logic circuit can accordingly calculate a first result data of the first application data. Finally, step 407 is executed to transmit, by the PaaS cloud server, the first result data to the first application via the virtual machine so as to complete the corresponding data computation.

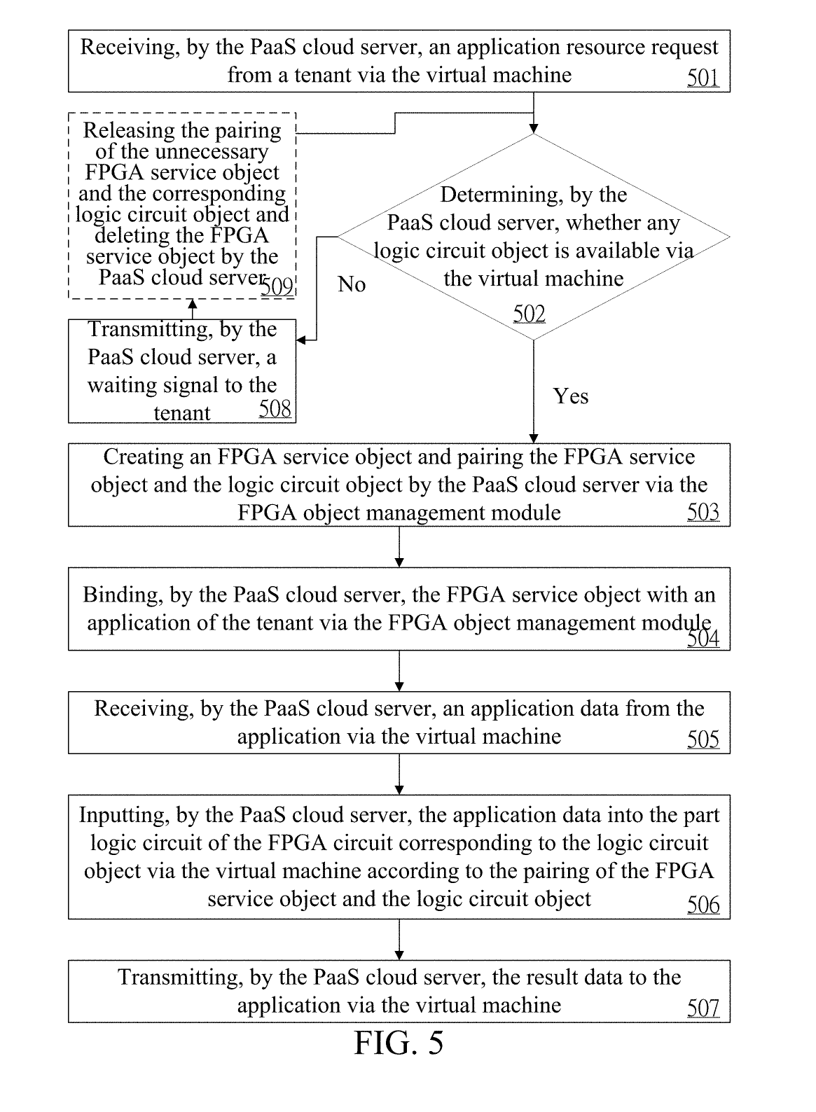

A fifth embodiment of the present invention is a multi-tenant operating method, and a flowchart diagram thereof is as shown in FIG. 5. The method of the fifth embodiment is for use in a PaaS cloud server (e.g., the PaaS cloud server of the aforesaid embodiments). The PaaS cloud server executes an FPGA object management module and a virtual machine, and the virtual machine controls an FPGA circuit. The FPGA circuit is divided into a plurality of part logic circuits, and the virtual machine configures a plurality of corresponding logic circuit objects respectively for the plurality of part logic circuits. Detailed steps of the fifth embodiment are as follows.

First, step 501 is executed to receive, by the PaaS cloud server, an application resource request from a tenant via the virtual machine. Step 502 is executed to determine, by the PaaS cloud server, whether any logic circuit object is available via the virtual machine according to the application resource request. If the determination result is yes, then step 503 is executed to create an FPGA service object and pair the FPGA service object and the logic circuit object determined as available by the PaaS cloud server via the FPGA object management module. Step 504 is executed to bind, by the PaaS cloud server, the FPGA service object with the application of the tenant via the FPGA object management module. Step 505 is executed to receive, by the PaaS cloud server, an application data from the application via the virtual machine.

Thereafter, step 506 is executed to input, by the PaaS cloud server, the application data into the part logic circuit corresponding to the logic circuit object via the virtual machine according to the pairing of the FPGA service object and the logic circuit object. In this way, the part logic circuit can accordingly calculate a result data of the application data. Step 507 is executed to transmit, by the PaaS cloud server, the result data to the application via the virtual machine so as to complete the corresponding data computation.

On the other hand, if it is determined that no logic circuit object is available in the step 502, step 508 is executed to transmit, by the PaaS cloud server, a waiting signal to the tenant via the virtual machine so as to notify the tenant to wait for an available resource to be released. It shall be particularly appreciated that, when the tenant is waiting for the resource to be released, an optional step 509 (which is represented by a dashed block) is executed if a tenant and the application thereof do not need to use the PaaS cloud server anymore. In the step 509, the PaaS cloud server releases the pairing of the unnecessary FPGA service object and the corresponding logic circuit object and deletes the FPGA service object via the FPGA object management module.

It shall be particularly appreciated that, the aforesaid application may be a general application, and it may also be implemented as a container application that is specific to the art. Therefore, the aforesaid application data, application resource request and the application may be implemented by technologies of a container data, a container resource request and a container. However, this is not intended to limit the implementation of the present invention.

According to the above descriptions, the PaaS cloud server and the multi-tenant operating method thereof according to the present invention mainly allocate an independent FPGA circuit to multiple tenants for operation by using the original characteristic of being programmable of the FPGA circuit based on the PaaS system, and manage the use of logic circuits of the independent FPGA circuit for the multiple tenants via the virtual machine of the PaaS cloud server. In this way, the hardware cost can be reduced remarkably, and meanwhile the efficiency in the service environment construction of the tenant side can be improved, thereby solving the problem in the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A multi-tenant operating method for a platform as a service (PaaS) cloud server, the PaaS cloud server executing a field-programmable gate array (FPGA) object management module and a virtual machine, and the virtual machine controlling an FPGA circuit, the multi-tenant operating method comprising:
receiving, by the PaaS cloud server, a first application resource request from a first tenant via the virtual machine;
determining, by the PaaS cloud server, that a first logic circuit object is available via the virtual machine according to the first application resource request, wherein the first logic circuit object corresponds to a first part logic circuit of the FPGA circuit;
creating a first FPGA service object and pairing the first FPGA service object and the first logic circuit object by the PaaS cloud server via the FPGA object management module;
binding, by the PaaS cloud server, the first FPGA service object with a first application of the first tenant via the FPGA object management module;
receiving, by the PaaS cloud server, a first application data from the first application via the virtual machine;
inputting, by the PaaS cloud server, the first application data into the first part logic circuit corresponding to the first logic circuit object via the virtual machine according to the pairing of the first FPGA service object and the first logic circuit object so that the first part logic circuit calculates a first result data of the first application data; and
transmitting, by the PaaS cloud server, the first result data to the first application via the virtual machine.

2. The multi-tenant operating method of claim 1, further comprising:
receiving, by the PaaS cloud server, a second application resource request from a second tenant via the virtual machine;
determining, by the PaaS cloud server, that a second logic circuit object is available according to the second application resource request via the virtual machine, wherein the second logic circuit object corresponds to a second part logic circuit of the FPGA circuit;
creating a second FPGA service object and pairing the second FPGA service object and the second logic circuit object by the PaaS cloud server via the FPGA object management module;
binding, by the PaaS cloud server, the second FPGA service object with a second application of the second tenant via the FPGA object management module;
receiving, by the PaaS cloud server, a second application data from the second application via the virtual machine;
inputting, by the PaaS cloud server, the second application data into the second part logic circuit corresponding to the second logic circuit object according to the pairing of the second FPGA service object and the second logic circuit object via the virtual machine so that the second part logic circuit calculates a second result data of the second application data; and
transmitting, by the PaaS cloud server, the second result data to the second application via the virtual machine.

3. The multi-tenant operating method of claim 1, further comprising:
receiving, by the PaaS cloud server, a second application resource request from a second tenant via the virtual machine; and
determining that no logic circuit is available in the FPGA circuit according to the second application resource request and transmitting a waiting signal to the second tenant by the PaaS cloud server via the virtual machine.

4. The multi-tenant operating method of claim 3, further comprising:
releasing the pairing of the first FPGA service object and the first logic circuit object and deleting the first FPGA service object by the PaaS cloud server via the virtual machine;
determining, by the PaaS cloud server, that the first logic circuit object is available according to the second application resource request via the virtual machine;
creating a second FPGA service object and pair the second FPGA service object and the first logic circuit object by the PaaS cloud server via the FPGA object management module;
binding, by the PaaS cloud server, the second FPGA service object with a second application of the second tenant via the FPGA object management module;
receiving, by the PaaS cloud server, a second application data from the second application via the virtual machine;
inputting, by the PaaS cloud server, the second application data into the first logic circuit corresponding to the first logic circuit object according to the pairing of the second FPGA service object and the first logic circuit object via the virtual machine so that the first logic circuit calculates a second result data of the second application data; and
transmitting, by the PaaS cloud server, the second result data to the second application via the virtual machine.

5. A platform as a service (PaaS) cloud server for multi tenants, comprising:
a transmission interface, being configured to connect with a field-programmable gate array (FPGA) circuit; and
a processor, being configured to execute an FPGA object management module and a virtual machine, and control the FPGA circuit via the virtual machine, the virtual machine comprising an FPGA processing module;
wherein the FPGA processing module is configured to:
receive a first application resource request from a first tenant;
determine that a first logic circuit object is available according to the first application resource request, wherein the first logic circuit object corresponds to a first part logic circuit of the FPGA circuit;
wherein the FPGA object management module is configured to:
create a first FPGA service object and pair the first FPGA service object and the first logic circuit object; and
bind the first FPGA service object with a first application of the first tenant;
wherein the FPGA processing module is further configured to:
receive a first application data from the first application;
input the first application data into the first part logic circuit corresponding to the first logic circuit object via the virtual machine according to the pairing of the first FPGA service object and the first logic circuit object so that the first part logic circuit calculates a first result data of the first application data; and
transmit the first result data to the first application.

6. The PaaS cloud server of claim 5, wherein the FPGA processing module is further configured to:
receive a second application resource request from a second tenant; and
determine that a second logic circuit object is available according to the second application resource request, wherein the second logic circuit object corresponds to a second part logic circuit of the FPGA circuit;
the FPGA object management module is further configured to:
create a second FPGA service object and pair the second FPGA service object and the second logic circuit object; and
bind the second FPGA service object with a second application of the second tenant;
wherein the FPGA processing module is further configured to:
receive a second application data from the second application;
input the second application data into the second part logic circuit corresponding to the second logic circuit object according to the pairing of the second FPGA service object and the second logic circuit object via the virtual machine so that the second part logic circuit calculates a second result data of the second application data; and
transmit the second result data to the second application.

7. The PaaS cloud server of claim 5, wherein the FPGA processing module is further configured to:
receive a second application resource request from a second tenant; and
determine that no logic circuit is available in the FPGA circuit according to the second application resource request and transmit a waiting signal to the second tenant.

8. The PaaS cloud server of claim 7, wherein the FPGA processing module is further configured to:
release the pairing of the first FPGA service object and the first logic circuit object and delete the first FPGA service object; and
determine that the first logic circuit object is available according to the second application resource request;
wherein the FPGA object management module is further configured to:
create a second FPGA service object and pair the second FPGA service object and the first logic circuit object;
bind the second FPGA service object with a second application of the second tenant;
wherein the FPGA processing module is further configured to:
receive a second application data from the second application;
input the second application data into the first logic circuit corresponding to the first logic circuit object according to the pairing of the second FPGA service object and the first logic circuit object via the virtual machine so that the first logic circuit calculates a second result data of the second application data; and
transmit the second result data to the second application.
